(19) United States
(12) Patent Application Publication
(10) Pub. No.: US 2015/0136478 A1
(43) Pub. Date: May 21, 2015

(54) CURRENT RETURN CONNECTING LOOM AND METHOD FOR MOUNTING ON A COMPOSITE FUSELAGE FRAME

(71) Applicant: LABINAL POWER SYSTEMS, Blagnac (FR)

(72) Inventors: Jean-Luc Biesse, Saint Lieux Les Lavaur (FR); Arnaud Camille Ayme, Toulouse (FR)

(73) Assignee: LABINAL POWER SYSTEMS, Blagnac (FR)

(21) Appl. No.: 14/396,574

(22) PCT Filed: Apr. 18, 2013
(86) PCT No.: PCT/FR2013/050864

§ 371 Date: Oct. 23, 2014

(30) Foreign Application Priority Data
Apr. 27, 2012 (FR) 1253942

(51) Int. Cl. H02G 3/04; H02G 3/32; H02G 1/06

(52) U.S. Cl. CPC H02G 3/0412; H02G 1/06; H02G 3/32
USPC 174/72 A; 29/525.08

(57) ABSTRACT

The invention aims to form equipotential connections between the various parts of a current return network. For this purpose, the invention provides a loom having a layer of conductors coated in a leak-proof jacket.

A connecting loom (30) of this type is suitable for connecting structural metal pieces in an available volume between a protection structure and a transverse frame made of composite carbon material or a cabin lining. In one embodiment, it comprises conductors (51) arranged parallel side by side which form a planar flexible layer (50), multi-point modular terminal connectors (32) and multi-point modular intermediate connectors (34), a protective jacket consisting of an external jacket (60) covering the layer in portions (60T) and a shared jacket (62) covering the edges (32b, 34b; 60b) of the connectors (32, 34) and of the external jacket (60) in portions (62T). Openings (54, 56) are formed on the connectors (32, 34) for fixing means. The conductors (51) are fixed individually in the connectors (32, 34), and are coated with leak-proofing product in a heat-shrinkable sleeve (46) at the connectors (32, 34).

### TECHNICAL FIELD

The invention relates to a connecting loom for a current return network which makes it possible to connect metal pieces, in particular electrical networks of next-generation aeroplanes having a skin formed of a composite material. The invention further relates to a method for mounting a loom of this type on an aeroplane fuselage frame of composite material.

The composite material of this next generation of skin comprises a heterogeneous material based on carbon fibres. Conventionally, the electrical interconnection functions were provided by the previous-generation aluminium skin. Specifically, aircraft manufacturers used it to return the current of equipment loads, for bringing all of the metal pieces to the same potential, for EMC (electromagnetic compatibility) protection of the electrical installation, and for dissipating lightning currents—indirect and induced—and electrostatic charges.

The invention may further be applied in any architecture or building through which electricity passes, necessitating current return control so as to make this architecture safe, in particular but not exclusively in the fuselages of passenger cabins of aeroplanes having a composite skin.

### PRIOR ART

Carbon composite materials are mediocre electrical conductors and are bad at withstanding Joule heating. Therefore, a covering of this type cannot be used to provide the aforementioned functions.

To make it possible to implement the electrical interconnection functions for an aeroplane having skin of a composite structure, an architecture composed of pieces made of metal has therefore been conceived to create in particular a current return electrical network. Overall, this network is composed of three longitudinal networks which extend over the length of the aeroplane fuselage:
an upper-part network (ceiling composed of metal pieces for supporting luggage compartments, cable trays and the central support;
a central-part network, comprising the profiled seat rails, the profiled metal cable supports and the like,
a lower-part network (floor) at the base of the profiled metal cargo rail and the like.

These longitudinal networks are interconnected transversely by metal pieces (cross-heads, structural rods etc.) or large-section cables or other electrically conductive elements. Effective meshing of a current return network is thus created so as to carry out the aforementioned functions.

However, the transverse interconnection of the current return networks has greatly reduced routing allocations for the electric wiring looms 3, as shown in FIG. 1 in the passenger cabin, behind the cabin lining panel 1. These routes are also localised along a structure frame 20 of carbon fibre composite material, known as a “carbon frame”, mounted on the aeroplane skin 5.

However, delimitation 6 of the EMC protection of these looms 3 has to be ensured in that they are close to an element of the current return network. The use of a wide-section cable is not suited to the environment, since it requires at least one electric wiring loom to be removed from the aeroplane so as to have a sufficient volume available. Available volumes 7 are located on either side of the heat and sound protection 40, between this protection and the carbon structural frame 20 mounted on the skin 5 and/or between this protection and the cabin lining panel 1.

Solutions for insertion into this volume 7 with elements of a suitable structure have been conceived:
metal fabric (canvas, mesh, knitted fabric, gauze etc.) co-hardened with and integral to the structural frame 20,
flat metal braid,
metal foil against the structure frame 20,
reinforced open sheath coming from the looms 3,
a plurality of small-section electric cables.

For combined reasons of conductivity, low density, cost and technical performance requirements, as well as behaviour in an aviation environment, the most suitable metal for the fabric, the foil, the braid or the small-section cables is aluminium. For the reinforced sheath, the preferred material is copper. However, all of these solutions have serious drawbacks for the following reasons.

As regards the addition of an aluminium fabric co-hardened with the structure frame 20:
aluminium and carbon have very different or even opposed coefficients of expansion/contraction as a function of temperature: unacceptable internal stresses set in over time;
the electrochemical compatibility of carbon and aluminium is very poor, and this may lead to galvanic corrosion, causing the aluminium to disappear;
the electrical connections between the aluminium in the form of fabric and the metal pieces of the current return network are extremely difficult to produce;
no electrical current should pass between the aluminium fabric and the carbon of the structure 20: electrical insulation has to be placed between them.

The use of a flat aluminium braid leads to the following problems:
there is no flat braid of nickeled aluminium wires suitable for use as an electrical connection, in particular in the field of aviation;
reliable leak-proofing is extremely difficult to achieve for connecting a braid, this being why a braid of this type is not used in the field of aviation;
much greater volume (by about 45%) than a cable of equivalent effective section;
same need for electrical insulation as with the fabric.

As regards the metal foil, integrating it into the aeroplane takes up several metres on a frame, and this length would prevent it from being positioned using a single holder. It is difficult to mount an additional electrical interface in the volume 7 provided for this purpose. Moreover, since the foil comes from a profile, electrically connecting two portions is very difficult and it is difficult to make the connections leak-proof in a reliable and long-term manner. Further:
the aforementioned problems of electrochemical incompatibility between aluminium and carbon are also relevant to the foil;
an additional set of fastenings has to be provided to form the fixing points to the carbon structural frame;
the foil is not very suitable for forming the direct electrical connection to the current return circuit in the upper and central parts of the aeroplane: these connections require large-section cable provided with terminals, increasing the number of electrical interfaces and the weight;
same need for electrical insulation between aluminium and carbon as for the fabric and the braid.

As regards the reinforced open sheath, the conductors which form the reinforcement are currently made of copper, and there is no need to reconsider the technology for reinforcements of this type: the pieces to which these reinforcements are connected by bracing at the ends thereof with copper blades are standardised, whereas aluminium contacts would lead to problems with airtightness and to the formation of aluminium oxide as a result. Further, the EMC protection of the electric strands which cover the sheath does not require much copper.

However, the links and connectors provided for the reinforcing sheaths were not designed to withstand the flow of current specified for the links to the electrical current return network. Thus, these reinforced open sheaths cannot be considered suitable for replacing large-section cables.

The use of small-section strand cables, to be interconnected and positioned in the available volume 7, leads to problems with fixing them to one another and to the carbon structural frame 20 without the insulators being worn down by vibrational friction—the presence of the insulators being intended to neutralise the aluminium/carbon electrochemical incompatibility. It is therefore necessary to immobilise these strands individually: fixing points will have to be added on the frame within the available space.

Further, at the end, each strand has to be leak-proofed separately so as to obtain effective leak-proofing. The weight and cost situations are therefore highly unfavourable with this solution. Further, the known end connection involves connecters having a normalised number of cables, generally six cables. If eight or ten cables are used, two connectors and two corresponding installations are therefore necessary for each end: in this respect too, the weight, volume and cost situations are also highly unfavourable.

Moreover, an intermediate connection involves cutting the cables of the main line at each branch and stripping all of the cables linked to the branch so as not to create inhomogeneity in the flow of electric current. The number of connectors to be provided is substantially equal to the number of cables to be linked at the branch. The same problems arise: weight, volume and cost problems and, in this case more particularly, reliability problems with the large number of cable cuts.

Known patents WO 2007/075931 and FR 2962712 disclose aircraft current return systems of which the cell is made of composite material. They do not disclose conductor layers of a sufficient flexibility.

### SUMMARY OF THE INVENTION

The invention therefore aims to provide a structure which can reduce the weight, volume, cost, reliability, leak-proofing, and electrical and electrochemical compatibility problems. For this purpose, the invention provides a loom having a layer of bare conductors which are all linked to connectors.

More specifically, the present invention relates to an equipotential connecting loom between structural metal pieces which are routed along a protection structure, said loom being located within an available volume extending between a transverse frame, made of a carbon-fibre-based composite material and known as a carbon frame, and a lining panel, to establish equipotential connections between the parts of a current return network. This loom comprises intermediate connectors, terminal connectors and a conducting device forming an equipotential connection between the intermediate connectors, for linking to the metal pieces by branching without the conductors being cut, and the terminal connectors coupled to the metal current return pieces, at least one protective jacket covering the device and end regions of the connectors, this jacket being for mechanical, electrical and electrochemical protection of the loom in connection with the heat and sound protection and/or with the carbon frame or the lining panel, characterised in that said conducting device is a planar layer, flexible in the longitudinal and transverse directions thereof, formed of non-insulated conductors arranged parallel side by side. The modular connectors, which are multi-point as regards the number of conductors, are connected to local leak-proofing means at each conductor to be connected.

In preferred embodiments:
each conductor is formed of a plurality of elementary aluminium blades grouped in a strand;
the connectors are surface-treated, in particular by nickel-plating, tinning, silvering or the like, to form an assembly by shrink-fitting to the corresponding pieces to be linked so as to prevent galvanic corrosion;
the intermediate multi-point connectors in connection with the layer and with the pieces to be linked can be positioned at any point in the layer by way of a “T” branch;
the terminal and intermediate connectors comprise aligned recesses, each conductor being inserted into and fixed in a recess;
the recesses of the terminal connectors are blind holes, and the recesses of the intermediate connectors are through-holes;
the protective jacket consists of an external jacket covering the layer and a shared jacket enclosing the edges of the connectors and of the external jacket;
the external jacket is formed of portions of material based on PVF (polyvinyl fluoride), PTFE (polytetrafluoroethylene) or the like, suitable for providing mechanical protection, as well as electrochemical and electrical insulation with the carbon frame and/or the heat and sound protection or the lining panel;
the shared jacket is formed of portions of heat-shrinkable polyolefin sheath or localised overmouldings of thermoplastic or thermosetting polymer material suitable for providing mechanical protection for leak-proof regions of the conductors in connection with the sides of the connectors;
the local leak-proofing means are formed of heat-shrinkable sleeves surrounding the conductors, which are coated with leak-proofing product at the leak-proofing regions, at the inputs of the connectors, so as to leak-proof each conductor individually;
the connectors are made of low-resistivity aluminium alloy.

Advantageously, the terminal and intermediate connections and the conductors of the layer can be adapted depending on the required criteria defined by the assembler: resistivity of the connections, transit and overload current levels, volume, number of fixing points and of pieces to be linked, particular mechanical interfaces etc.

The invention further relates to a method for mounting the loom on an aeroplane fuselage carbon frame. In this method, a double-sided adhesive coating is glued to the external jacket of the loom for direct installation of the layer on the carbon frame, the peel-off film is gradually pulled back, and the loom is applied to the frame. The positioning of the loom is subsequently provided and secured by spring pins, which come to be pressed into compartments formed in the frame in advance, and the connectors are rigidly fixed to the pieces to be linked. If the layer is installed between the heat and sound protection and the cabin lining, rigid supports and flexible supports of the layer are provided along the heat and sound protection.

Advantageously, the loom is positioned by way of pins having two legs having ends axially offset towards the outside by an angle suitable for making the pin unreleasable once it is installed in the compartment thereof. Further, the loom may also be supported between two connectors by local fastenings, in particular by wrapping in hose clamps in connection with a structural element.

### DESCRIPTION OF THE DRAWINGS

Further aspects and particulars of the implementation of the invention will become apparent upon reading the following detailed description, accompanied by appended drawings in which, respectively:

FIG. 1 is a longitudinal section of a prior art current return network (referred to above);

FIGS. 2, 2a and 2b are cross-sectional views, in the plane II-II, and a detail of this cross section at a carbon frame, of a part of a passenger cabin of an aeroplane equipped with an example loom according to the invention;

FIGS. 3a and 3b are a front view and a top view of the loom of FIG. 1;

FIGS. 4a and 4b are a partial front view and a partial cross-sectional view, in the plane IV-IV, of the layer of conductors of the aforementioned example loom;

FIG. 5 is a cross-sectional view of a conductor of the aforementioned layer;

FIGS. 6a and 6b are a front view and a detail of an example loom terminal connector in connection with leak-proofing sleeves according to the invention;

FIG. 7 is a top view of an example loom intermediate connector in connection with leak-proofing sleeves according to the invention;

FIGS. 8a and 8b show two steps of covering a layer of conductors to form the protective jacket on the layer and on the connectors;

FIGS. 9a to 9c are a front view (FIG. 9a) and cross-sectional views (FIGS. 9b and 9c) in the planes BB and CC of mounting a loom on the heat and sound protection with an appropriate alternation of rigid and flexible supports;

FIGS. 10a and 10b are two side views of mounting the loom on a carbon frame, along a linear portion and an angled portion of this frame respectively;

FIGS. 10c and 10d are enlarged views of a loom-holding pin, in perspective view and in the V-V direction of FIG. 10c, respectively;

FIG. 11 is an example of installation of the aforementioned loom on the upper part of the current return network with conventional local fastenings and intermediate and terminal connections, and

FIGS. 12a and 12b show two examples of fixing by wrapping the loom in particular clamps.

### DETAILED DESCRIPTION

In the various drawings, like reference numerals or those having the same root relate to like or technically equivalent elements. The terms “upper”, “central” and “lower” relate to relative positioning in the standard mode of use or mounting. The terms “longitudinal” and “transverse” qualify elements which extend in a direction and in a plane perpendicular to said direction; “longitudinal” relates in particular to the fuselage axis of an aeroplane.

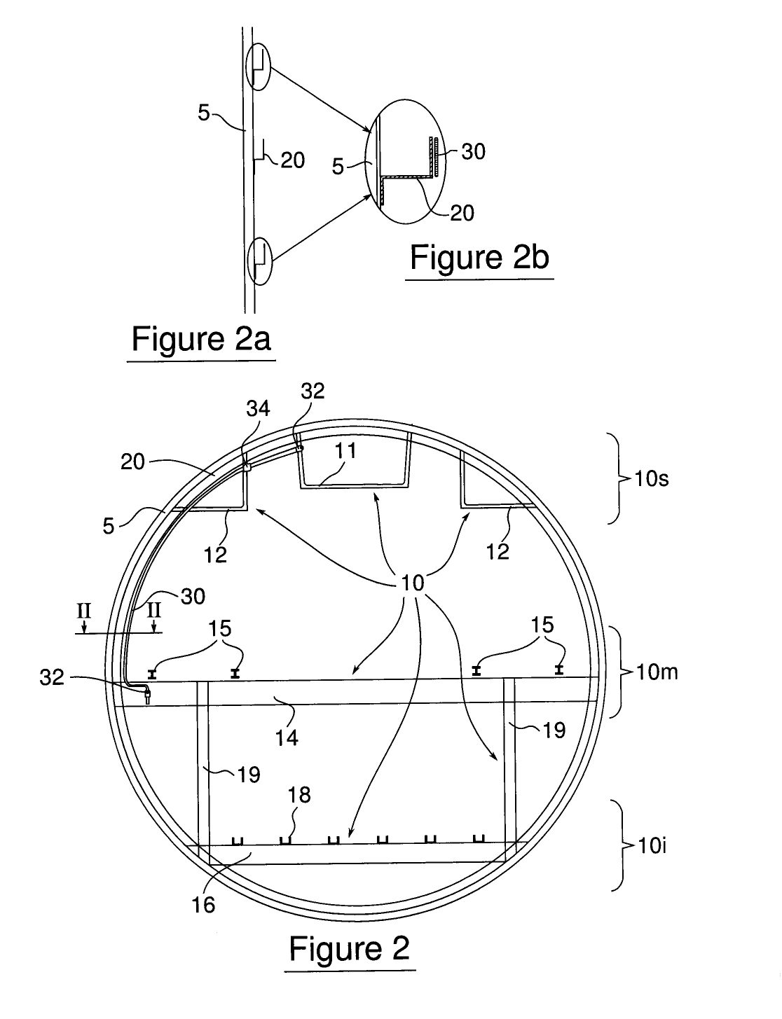

Referring to the cross section of the passenger cabin of FIG. 2, the carbon material aeroplane skin 5 appears in the form of a curved wall to which upper, central and lower longitudinal parts 10s, 10m, 10i of the current return network 10 are fixed.

The upper part 10s of the network comprises a central support 11 and metal side supports 12. The central support 11 receives cabling and technical equipment, whilst the side supports 12 support the luggage compartments.

The central part 10m consists of a metal cross-head 14 on which the metal rails 15 of the passenger seats are mounted.

The lower part 10i comprises another metal cross-head 16 for supporting the metal cargo rails 18. Metal structural rods 19 link the central metal cross-head 14 and the lower metal cross-head 16.

The upper, central and lower parts are mechanically interconnected by the transverse structural frame 20 made of composite material based on carbon fibres. On this carbon frame 20, an example planar, flexible, equipotential connecting loom 30 according to the invention electrically links the supports 11 and 12 of the upper part 10s to the central cross-head 14.

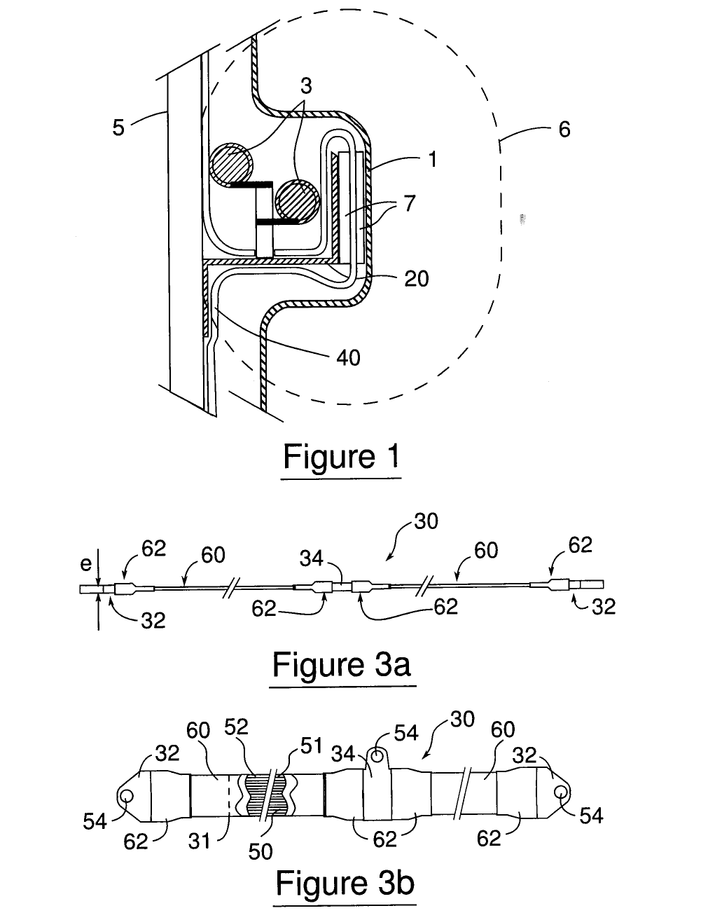

In the routing example of FIG. 2, the loom 30 comprises two terminal connectors 32, fixed to the central support 11 and to the central cross-head 14, as well as an intermediate connector 34 fixed to a side current return support 12. The loom is planar and flexible so as to make a link possible within an available volume defined between the carbon frame 20 and a heat and sound protection 40 of the aeroplane skin 5 (see FIG. 1).

The cross-sectional view of FIG. 2a in the plane II-II of FIG. 2 shows the sequence of carbon frames 20 formed along the aeroplane skin 5 in the image of the structure shown in FIG. 1. The detail of FIG. 2b schematically shows the presence of the loom 30 according to the invention in connection with the frame 20.

The front view of FIG. 3 shows the relative small thickness “e” of a loom 30 according to the invention, comparable with the thickness of an individual conductor, or approximately 3 mm for so-called “AWG” calibration gauges 12, excluding the intermediate and terminal connectors 34, 32.

The flexibility of the loom 30 results from the flexibility of the layer 50 of metal conductors 51, preferably made of aluminium or aluminium alloy, which form the base of the loom 30, as shown by way of the shaded part of this loom in the top view of FIG. 3b. In a variant, the assembly links 52, which are perpendicular to the conductors 51 and distributed along the layer 50, hold the conductors 51 parallel and side by side.

In the example, the number of conductors 51 is equal to 10. More generally, the section of each conductor, the number of conductors, the links between the conductors and the connectors, as well as the links between the connectors and the pieces to be linked, are determined so as to preserve the equipotential electric current return characteristic within an installation space compatible with the available volume. Different models of conductor layers which thus form an equipotential connection can thus be manufactured and stored.

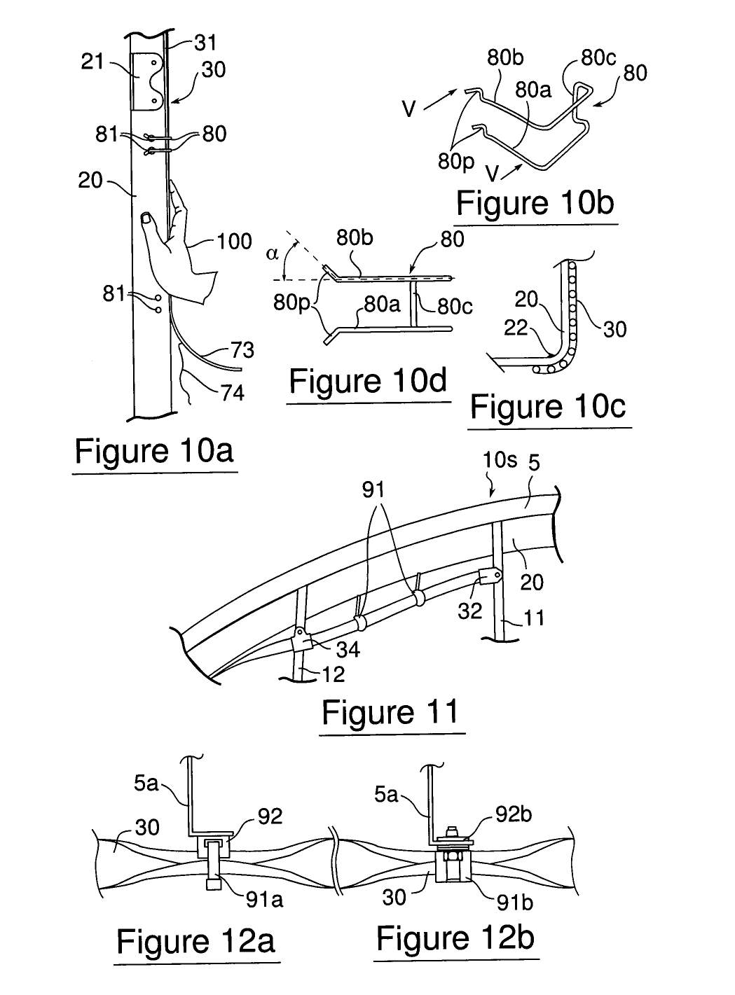

When a given layer is being positioned, specific tools make it possible to cut and crimp each layer portion in the connectors 32 and 34 so as to produce the desired loom. The connection of the loom can thus be adapted depending on the configuration and the dimensions of the installation to be produced. In particular, this connection can be adapted to the resistivity of the connection to be connected, the transit or overload current, the number of fixing points and the volume of the installation, as well as the number of pieces to be linked. Reference positioning marks 31 are formed on the jacket 60 for alignment with structural elements (see the description of an example of mounting the loom, in reference to FIG. 10a).

The shape of the connectors makes it possible to reduce the total weight thereof to an absolute minimum. In particular, the thickness “e” of the connectors 32 and 34 is barely greater than the maximum diameter of the conductors 51, so as to maintain a robustness compatible with the presence of recesses or holes passing through them.

The connectors advantageously consist of an aluminium alloy for electrical use, and therefore have a low resistivity. The connectors are preferably surface-treated (nickel-plated, tinned, silvered etc.) in such a way that this surface is low-resistivity and forms electrical connections at the interface with a shrink-fitting to the supports 11, 12, and the cross-heads 14, 16 which are to be linked (cf. FIG. 2). This eliminates the risks of galvanic corrosion at the electrical connection. Preferably, the connectors are fixed to the supports via the openings 54.

The layer is also modular so as to make it more easily adaptable: the number and section of the conductors, the dimensions of the connectors, the thickness and width of the layer, and the number of intermediate connectors can be adjusted. Further, the electrical and mechanical linking interfaces can be adapted to the piece to be linked.

The layer 50 is covered in an external protective jacket 60 of PVF (polyvinyl fluoride) or PTFE (polytetrafluoroethylene) plastics material or the like, forming a mechanical protection sheath. This jacket 60 further makes it possible to provide the electrochemical and electrical insulations of the loom with the carbon frame.

Finishing at the terminal and intermediate connectors 32, 34 is provided by way of portions of heat-shrinkable polyolefin sheath which form a shared jacket 62. This shared jacket encloses the edges 60b of the external jacket 60 at one end thereof, and covers the terminal and intermediate connectors 32, 34 in part at the other end thereof. It thus mechanically protects, by covering them, the individual leak-proofings formed on each conductor 51 of the layer 50. A more detailed description is given in reference to the assembly in FIGS. 8a and 8b.

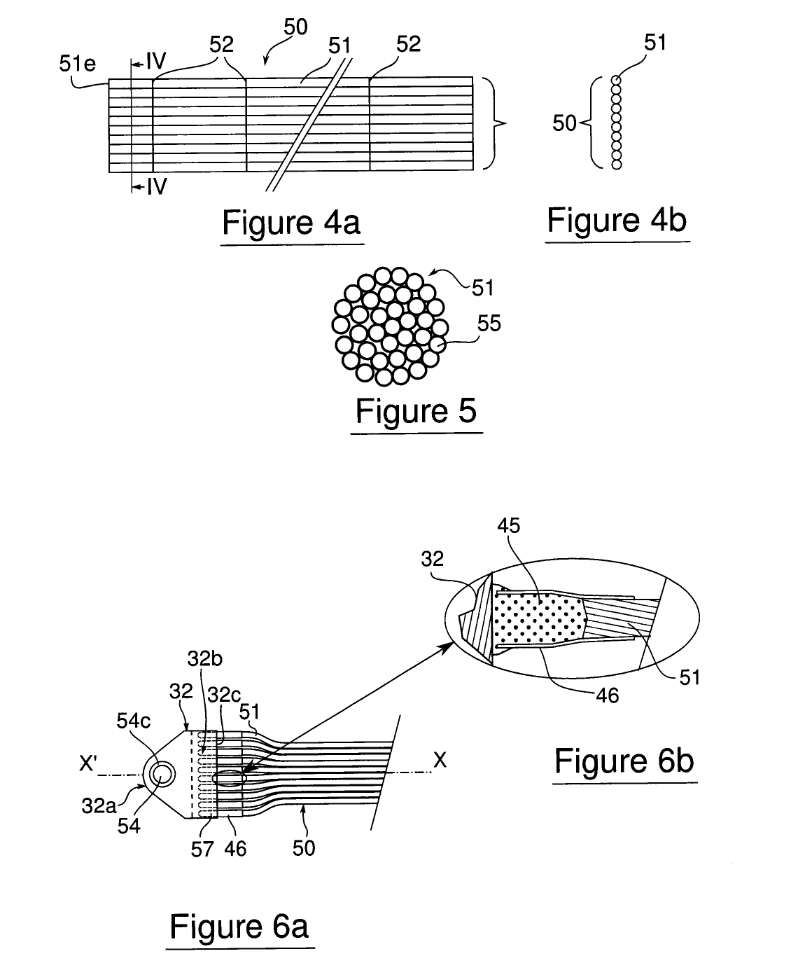

The front view and the cross-sectional view, in the plane IV-IV, of FIGS. 4a and 4b show the layer 50 of conductors 51, which in the example are rigidly fixed by assembly links 52 regularly spaced along the layer 50. The interval between two links is further adapted so as to make it possible for the planar layer thus formed to retain sufficient flexibility. If appropriate, these assembly links may also not be present.

Each conductor 51 is formed of elementary aluminium blades 55 grouped in a strand, as shown in the cross-sectional view of FIG. 5. In this example, which is of course non-limiting, the conductor 51 has an “AWG 12” gauge or a diameter of approximately 2 mm. For improvements in flexibility and weight, the conductors are advantageously bare, in other words free of electrical insulation.

The terminal connectors 32, such as that shown in the front view of FIG. 6a and the detail of FIG. 6b, have individually aligned recesses 57 spread out over the entire width of one connector side 32c, each recess being able to receive a conductor end 51 to be crimped therein. Alternatively, the conductors 51 are fixed in the recesses 57 by soldering, bracing, compaction, ultrasound etc. For the terminal connectors, the recesses 57 are blind holes, formed along the edge 34b of said connectors.

The terminal connectors 32 are linked to the metal support pieces 11 and cross-heads 14 (FIG. 2) using appropriate fastenings and interfaces. The electrical contact zone 54c surrounding the fixing opening 54 is extended so as not to exceed predetermined limits for Joule heating.

In the example, the fastenings are provided by way of screws through the openings 54. The terminal connector 32 shown has an axis of longitudinal symmetry X′X which has a pointed overhang 32a, the opening 54 being formed substantially in the centre of this end. A fastening interface of this type may undergo semi-piercing, bending at a given angle etc. In other variants, the interface may be quick-disconnect, ¼-turn or the like.

The connection between the conductors 51 and the terminal connector 32 is leak-proofed by coating with a leak-proofing resin in the regions known as leak-proofing regions 45, for example with polyester resin, epoxy resin or the like, covered with a heat-shrinkable sleeve 46. The conductors are thus leak-proofed individually.

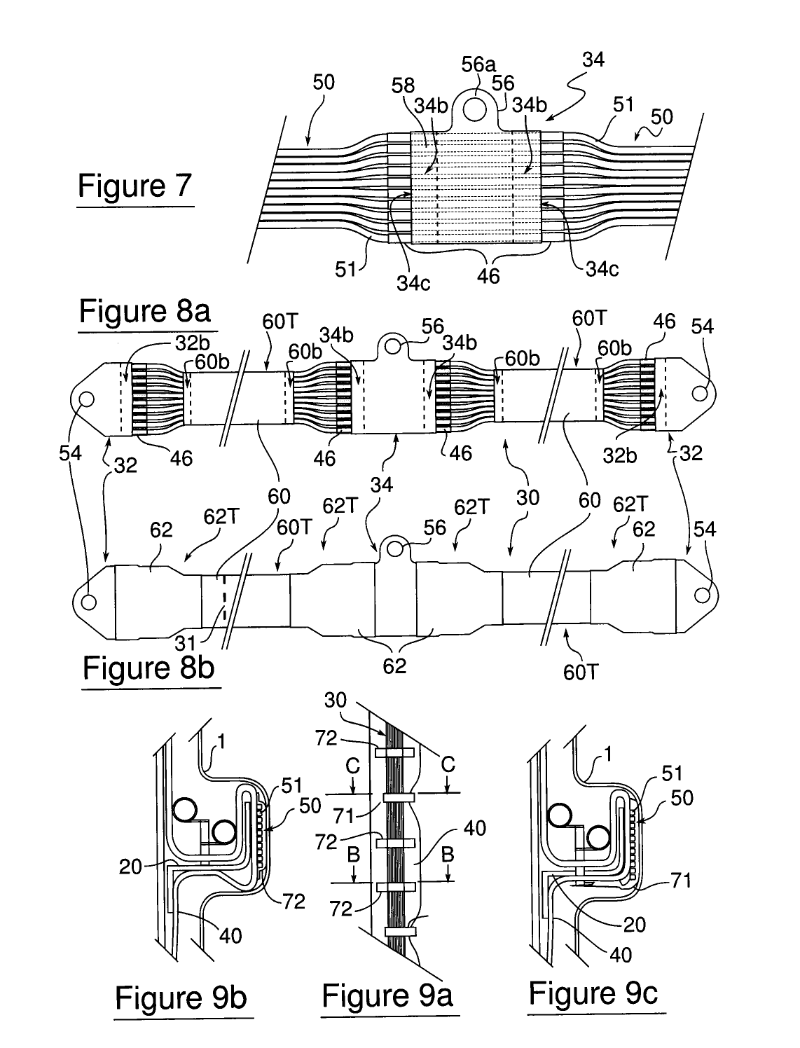

In relation more specifically to the intermediate connectors 34, an example is shown in the front view of FIG. 7. As for the terminal connectors, the intermediate connectors 34 are linked to the metal support pieces 12 (FIG. 2) by way of appropriate fastenings and interfaces. The extent of the electrical contact zone 56a surrounding the fixing opening 56 is optimised as a function of the heat release, and the fastenings are provided, for example, by way of screws through the openings 56.

Likewise, the interface of the multi-point intermediate connector 34 with the planar layer 50 is formed by inserting each conductor 51 into an individual recess 58.

These recesses are formed by longitudinal through-holes 58, and the conductors 51 are fixed in these holes as in the recesses of the terminal connectors. Leak-proofing is provided in connection with each of the sides 34c of the connector 34 by reproducing the leak-proofing disclosed for the terminal connectors 32 in reference to FIGS. 6a and 6b:

combining a leak-proofing resin and a heat-shrinkable sleeve 46. This solution has the following advantages:
no cutting the conductors 51 which form an equipotential connection, resulting in an improvement in contact resistance and an increase in the reliability of the connection;
improvement in weight;
possibility of fixing each conductor in part in the recesses of the intermediate connector 34 (fixing by crimping or the like, as for fixing in the terminal connectors), close to one or both sides 34c, at the edges 34b: fixing merely on one side makes it possible to save on the other fastening, but leads to doubling of the contact resistance between the conductor and the intermediate connector.

The interface of the intermediate connector 34 with other metal pieces of the aeroplane is adapted to the specific requirements. Thus, the intermediate connectors 34 may have a single overhang 35 with a screw-fixing opening 54 (cf. FIGS. 3a and 3b) or a plurality of overhangs with the same types of fixing.

As for the terminal connectors, this interface may undergo semi-piercing, bending at a given angle or the like. Equally, other variants of this interface may be quick-disconnect, ¼-turn or the like.

These intermediate connectors make it possible to connect a current return cable from a piece of equipment as close as possible to this piece of equipment, forming a “T” branch.

Overall front views of an example of assembling a loom 30 according to the invention in two steps of covering with a shared jacket are shown in FIGS. 8a and 8b. The loom comprises the layer of conductors 50 with multi-point terminal connectors 32 and a multi-point intermediate connector 34.

The assembly of the layer 50 of bare aluminium conductors 51 with the multi-point terminal connectors 32 and the multi-point intermediate connector 34 is provided for example by crimping: the conductors 51 are crimped in a single operation using specific tools in each connector 32 and 34. After crimping, the electrical and mechanical performances are achieved:
the electrical resistance of a crimp is strictly less than the electrical resistance of an equivalent length of conductor without crimping;
in a given conductor, the electrical resistances of the crimps are all within a range of variation from one another of approximately 5%, making it possible to prevent inhomogeneous currents from circulating in the conductors 51 of the layer 50;
the tensile strength is at least equal to the elastic limit of the conductor 51.

The process of providing an example planar flexible loom for equipotential connection starts with cutting to size the necessary lengths of conductors 51 made of aluminium alloy, advantageously preformed in a planar layer. The preparation of the ends 51e for crimping starts with withdrawing, if necessary, the assembly links 52 which could potentially obstruct the assembly of the end for crimping. Each conductor 51 is subsequently precisely adjusted on a template (not shown). The conductors are cut using suitable tools.

Each conductor 51 is subsequently introduced into the intended recess 57 or hole 58 in the terminal or intermediate connectors 32, 34. The conductors 51 must not cross.

The operation starts (FIG. 8a) with covering the layer of conductors 50 with portions 60T which form the external jacket 60, formed by wrapping with a flexible mechanical protection and electrical and electrochemical insulation film, for example made of PTFE, which is pre-glued on the internal face thereof. Mounting marks 31 are formed on the portions 60T.

Subsequently, the layer between the connectors 32, 34 and the external jacket 60 is covered with a heat-shrinkable sheath 62 in portions 62T (FIG. 8b). These portions form the shared jacket 62 by covering, on the one hand, the edges 60b of the portions 60T of the external jacket 60 and, on the other hand, the connection regions 46 of the conductors 51 to the connectors 32, 34, until the edges 32b and 34b of these connectors are covered, so as to guarantee mechanical protection of the leak-proofing regions 46 of the conductors, and finishing is carried out at the connectors 32, 34.

Mounting a loom 30 protected in this manner on a portion of the heat and sound protection 40 is shown in the front view of FIG. 9a and in the cross-sectional views (in the planes BB and CC) of FIGS. 9b and 9c. The loom 30 is routed under supports between the protection 40 and the cabin lining 1. It is joined to the protection 40 using rigid and flexible supports 71 and 72 respectively. Each rigid support 71 (FIG. 9c) has an “L” shape in this example, and surrounds the layer 50 of conductors 51 on one leg of the “L”. It is fixed to the heat and sound protection 40 via the other leg of the “L”.

Between two rigid supports 71, flexible supports of a textile material or the like form straps 72 (FIG. 9b). These straps are connected to the protection 40 by appropriate means: sewing, gluing, soldering, self-adhesive strip or the like. These straps prevent the potential bulges that the loom 30 might form between two rigid supports 71, and thus prevent premature wear thereof due to friction.

Mounting a loom 30 on a linear portion of the carbon frame 20, before the heat and sound protection and the lining panel 1 of the cabin are positioned, is shown in the side view of FIG. 10a. Before the loom is installed, a double-sided adhesive strip 73 is glued to the face of the loom 30 which is to be rigidly fixed to the frame 20.

The installation of the loom 30 starts with aligning a starting positioning matchmark 31 formed on the loom 30 with a structural element of the frame 20, an edge of a frame-holding piece 21 in the example shown.

The operator 100 subsequently gradually pulls back the peel-off film 74 to expose the adhesive face of the strip 73, and applies the loom 30 to the frame 20 so as to glue it. This non-structural gluing makes it possible to keep the loom in place, making it easier to position and fix. The positioning of the loom 30 is subsequently provided and secured by spring pins 80, which come to be pressed into accommodating notches 81 formed in the frame 20. Advantageously, the interval and the shape of the pins 80 are variable and adapted to the environment and to the mechanical interfaces.

On an angled portion 22 of the frame 20, as shown in the schematic drawing of FIG. 10c, the curved surface may receive the loom 30. In particular, because of the flexibility of the layer of conductors, the loom 30 can be installed on concave, convex or more complex surfaces.

The detail of FIG. 10b shows a spring pin 80. This pin consists of two angled arms 80a and 80b, linked by a bridge 80c. At each arm end 80a, 80b, a fold with an end 80p is formed so as to be accommodated in a notch 81 in the frame 20. As shown in the view of FIG. 10d, in the direction V-V of FIG. 10b, the ends 80p are axially offset towards the outside by an angle α with respect to the legs 80a and 80b. This angle α is adapted to make the pin naturally unreleasable once it is installed in the compartment 81 thereof, by way of the spring effect of the legs 80a and 80b thereof.

In some regions, positioning of the loom 30 by gluing to the frame 20 is made more difficult by the mechanical environment or the volume. As is shown in FIG. 1, in the region of the upper part 10s of the current return network, the loom 30 is positioned using local fastenings 91 (collars, flanges etc.) on the frame 20. On the supports 11 and 12, the fixing is preferably provided using the terminal and intermediate connectors 32, 34.

By way of example, two fastenings by wrapping the loom 30 in particular hose clamps are shown in FIGS. 12a and 12b. Referring to FIG. 12a, the loom 30 is wrapped locally and held by a plastics material cable tie 91a in connection with a structural element 5a via a fixed support 92. In FIG. 12b, the loom 30 is wrapped in a P collar 91b, used as standard in aeroplanes for fixing looms. The P collar 91b likewise makes fixing to the structural element 5a possible via a mounting element 92b.

The invention is not limited to the embodiments disclosed and shown. It is possible for example to provide hybrid intermediate connectors formed in part by through-holes and by blind recesses to accommodate the conductors. Further, the conductors are preferably made of aluminium, but could potentially equally be made of copper alloy. Further, the rigid fixing of the connectors to the pieces to be linked may equally be provided by screwing, riveting, flanging, soldering, brazing or any like means.

1. Loom for equipotential connection between metal structural pieces (10; 11, 12, 14, 16) routed along a protection structure (40), located in an available volume (7) extending between a transverse frame (20), made of a carbon-fibre-based composite material and known as a carbon frame, and a lining panel (1), to establish equipotential connections between the parts of a current return network, comprises intermediate connectors (34), terminal connectors (32) and a conducting device (50) forming an equipotential connection between the intermediate connectors (34), for linking to the metal pieces (12) by branching without the conductors being cut, and the terminal connectors (32) coupled to the metal current return pieces (11, 14), at least one protective jacket (60, 62) covering the device (50) and end regions (32b, 34b) of the connectors (32, 34), this jacket (60, 62) being for mechanical, electrical and electrochemical protection of the loom in connection with the heat and sound protection (40) and/or with the carbon frame (20) or the lining panel (1), characterised in that said conducting device is a planar layer (50), flexible in the longitudinal and transverse directions thereof, formed of non-insulated conductors (51) arranged parallel side by side, and in that the connectors are modular and multi-point as regards the number of conductors (51) and are connected to local leak-proofing means (45, 46) at each conductor (51) to be connected.

2. Equipotential connecting loom according to claim 1, wherein each conductor (51) is formed of elementary aluminium blades (55) grouped in a strand.

3. Equipotential connecting loom according to claim 1, wherein the connectors (32, 34) are surface-treated, using a treatment selected from nickel-plating, tinning and silvering, to form an assembly by shrink-fitting to the corresponding pieces (11, 12, 14, 16) to be connected so as to prevent galvanic corrosion.

4. Equipotential connecting loom according to claim 1, wherein the terminal and intermediate connectors (32, 34) comprise aligned recesses (57, 58), each conductor (51) being inserted into and fixed in a recess (57, 58).

5. Equipotential connecting loom according to claim 4, wherein the recesses of the terminal connectors (32) are blind holes (57), and the recesses of the intermediate connectors (34) are through-holes (58).

6. Equipotential connecting loom according to claim 1, wherein the protective jacket consists of an external jacket (60) covering the layer (50) and a shared jacket (62) enclosing the edges (32b, 34b; 60b) of the connectors (32, 34) and of the external jacket (60).

7. Equipotential connecting loom according to claim 6, wherein the external jacket (60) is formed of portions (60T) of material based on polyvinyl fluoride, known as PVF, or polytetrafluoroethylene, known as PTFE, suitable for providing mechanical protection, as well as electrochemical and electrical insulation with the carbon frame and/or the heat and sound protection or the lining panel.

8. Equipotential connecting loom according to claim 6, wherein the shared jacket (62) is formed of portions (62T) of heat-shrinkable polyolefin sheath or localised overmouldings of thermoplastic or thermosetting polymer material suitable for providing mechanical protection for leak-proof regions (45) of the conductors (51) in connection with the sides (32c, 34c) of the connectors (32, 34).

9. Equipotential connecting loom according to claim 8, wherein the local leak-proofing means are formed of heat-shrinkable sleeves (46) surrounding the conductors (51), which are coated with leak-proofing product at the leak-proofing regions (45) so as to leak-proof each conductor (51) individually.

10. Equipotential connecting loom according to claim 1, wherein the connectors (32, 34) are made of low-resistivity aluminium alloy.

11. Method for mounting a loom according to claim 1 on an aeroplane fuselage frame made of composite material, characterised in that a double-sided adhesive coating (70) is glued to the external jacket (60) of the loom (30) for direct installation of the layer (50) on the carbon frame (20), in that the peel-off film (73) is gradually pulled back and the loom (30) is applied to the frame (20), in that the positioning of the loom is subsequently provided and secured by spring pins (80), which come to be pressed into compartments (81) formed in the frame (20) in advance, in that the connectors (32, 34) are rigidly fixed to the pieces (11, 12, 14, 16) to be linked, and in that, if the layer is installed between the heat and sound protection and the cabin lining, rigid supports (71) and flexible supports (72) of the layer (50) are provided along the heat and sound protection (40).

12. Method for mounting a loom according to claim 11 on an aeroplane fuselage frame made of composite material, characterised in that the loom is positioned by way of pins (80) having two legs (80a, 80b) having ends (80p) axially offset towards the outside by an angle (a) suitable for making the pin (80) unreleasable once it is installed in the compartment (81) thereof.

13. Mounting method according to claim 12, wherein, the loom (30) is also supported between two connectors (32, 34) by local fastenings (91), in particular by wrapping in hose clamps (91a, 91b) in connection with a structural element (5a).
